(19) United States
(12) Patent Application Publication
(10) Pub. No.: US 2013/0127267 A1
(43) Pub. Date: May 23, 2013

(54) CYLINDRICAL LINEAR MOTOR WITH LAMINATED STATOR

(71) Applicants: Michael Fick, Sondernau (DE); Armin Stäblein, Fladungen (DE); Rolf Vollmer, Gersfeld (DE)

(72) Inventors: Michael Fick, Sondernau (DE); Armin Stäblein, Fladungen (DE); Rolf Vollmer, Gersfeld (DE)

(73) Assignee: Siemens Aktiengesellschaft, Munchen (DE)

(21) Appl. No.: 13/469,275

(22) Filed: May 11, 2012

(30) Foreign Application Priority Data
May 13, 2011 (EP) 11166064

(51) Int. Cl. H02K 41/03

(52) U.S. Cl. CPC H02K 41/031
USPC 310/12.18

(57) ABSTRACT

A cylindrical linear motor includes a cylindrical rotor, and a cylindrical stator arranged in coaxial relationship to the rotor. The stator has a plurality of annular coils which are arranged in coaxial relationship, and a ferromagnetic stator core which includes a plurality of individual laminations which are aligned radially or arranged in a star shape. This reduces a field displacement caused by eddy currents, as a result of which ultimately a time delay in the force buildup is also reduced.

### CROSS-REFERENCES TO RELATED APPLICATIONS

This application claims the priority of European Patent Application, Serial No. EP 11166064, filed May 13, 2011, pursuant to 35 U.S.C. 119(a)-(d), the content of which is incorporated herein by reference in its entirety as if fully set forth herein.

### BACKGROUND OF THE INVENTION

The present invention relates to a cylindrical linear motor with laminated stator.

The following discussion of related art is provided to assist the reader in understanding the advantages of the invention, and is not to be construed as an admission that this related art is prior art to this invention.

Linear motors can be implemented in a cylindrical design. Linear motors of said type are typically employed for initiating linear movements whose frequency lies in the single-digit hertz range. In this case the stator core is embodied as a hollow cylinder and on its inside has slots running in the circumferential direction. Annular coils are inserted into said slots.

However, cylindrical linear motors are also required for driving functions which require higher dynamic characteristics. For example, linear motors of said type are designed to be used for a frequency of 25 Hz and more. In such applications, losses result in the stator iron due to eddy currents. In addition the eddy currents cause a field displacement which leads to a time delay in the force buildup.

No cylindrical linear motors have been used in the prior art for highly dynamic driving functions. Known cylindrical linear motors are configured more for low movement speeds and can be manufactured using stators made of solid iron.

It would therefore be desirable and advantageous to provide an improved cylindrical linear motor to obviate prior art shortcomings and to realize driving functions having higher dynamics.

### SUMMARY OF THE INVENTION

According to one aspect of the present invention, a cylindrical linear motor includes a cylindrical rotor, and a cylindrical stator arranged in coaxial relationship to the rotor, the stator having a plurality of annular coils which are arranged in coaxial relationship, and a ferromagnetic stator core which includes a plurality of radially aligned individual laminations.

What is advantageously achieved by means of the lamination of the stator core is that the eddy currents in the stator core or stator iron are reduced and as a result the losses are also minimized. Furthermore this makes a field displacement all the less likely to occur, with the result that a faster force buildup is possible.

According to another advantageous feature of the present invention, each of the individual laminations can have a comb-like structure. When arranging the individual laminations adjacent to one another in the circumferential direction, the individual laminations forcibly engage with the tooth tips and are radially aligned. This results in a hollow cylindrical lamination arrangement which substantially constitutes the stator core and which on the inside has slots running in the circumferential direction, into which slots the annular coils can be inserted.

According to another advantageous feature of the present invention, the number of annular coils of the stator can be a multiple of three. This enables the cylindrical linear motor to be used for a three-phase system.

According to another advantageous feature of the present invention, the stator core can have teeth running in the circumferential direction, with each of the teeth having a tooth tip for arrangement of a tooth tip ring. Tooth tip rings of this type serve not only to collect the magnetic flux, but also to fix the individual laminations of the lamination arrangement in position.

According to another advantageous feature of the present invention, the individual laminations of the stator core can form a lamination arrangement which has one or more interruptions in the tangential or circumferential direction, into each of which a stator comb element is inserted. The terminals of the windings can be brought out in said stator comb element.

According to another advantageous feature of the present invention, the stator comb element can have an axially running channel in which a connecting circuit of the annular coils is arranged. This enables the comb element to be used also for accommodating and fixing switching elements for the circuit or interconnection of the windings.

According to another advantageous feature of the present invention, the stator comb element can have an electrically insulating plastic part, an electrically insulated cast part or an electrically insulated sintered part. Materials of this kind can ensure that the connecting circuit of the windings can be safely accommodated at the stator.

According to another advantageous feature of the present invention, the individual laminations of the stator core can be fixed in position at each axial end of the stator by fixing rings, respectively. In this way the individual laminations are retained radially fixed or pre-fixed at the stator core.

According to another advantageous feature of the present invention, the stator core can be enclosed by a housing or a cooling jacket. In this way it is possible to protect the stator or cool it as appropriate.

According to another advantageous feature of the present invention, the stator core can be sealed with a resin. As a result, any gaps between the individual laminations, which are in fact arranged in a star shape, can be closed, thereby stabilizing the stator core.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a cross-section through a part of a cylindrical linear motor according to the present invention;

FIG. 2 is a schematic illustration of a stator lamination of the cylindrical linear motor of FIG. 1;

FIG. 3 is a detailed view, on an enlarged scale, of a portion of the cylindrical linear motor of FIG. 1;

FIG. 4 is an oblique view of a stator of a cylindrical linear motor according to the present invention;

FIG. 5 is a perspective view of a stator comb element;

FIG. 6 is a front face view of a part of the stator of FIG. 4 in the region of the stator comb element; and

FIG. 7 is a cross-section through a stator of a cylindrical linear motor according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

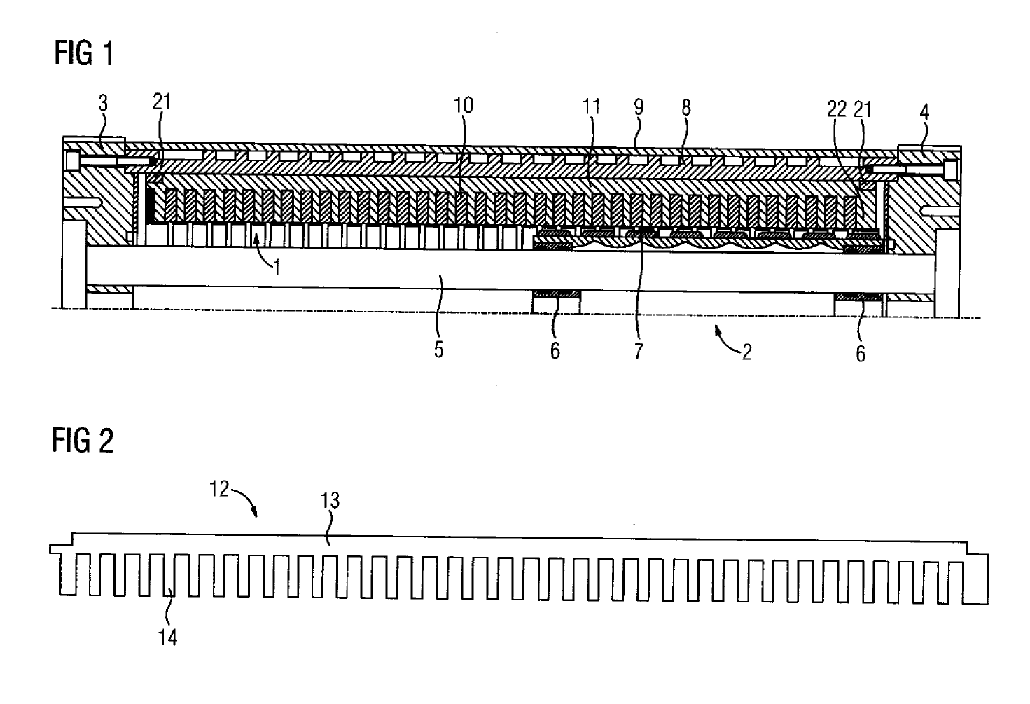

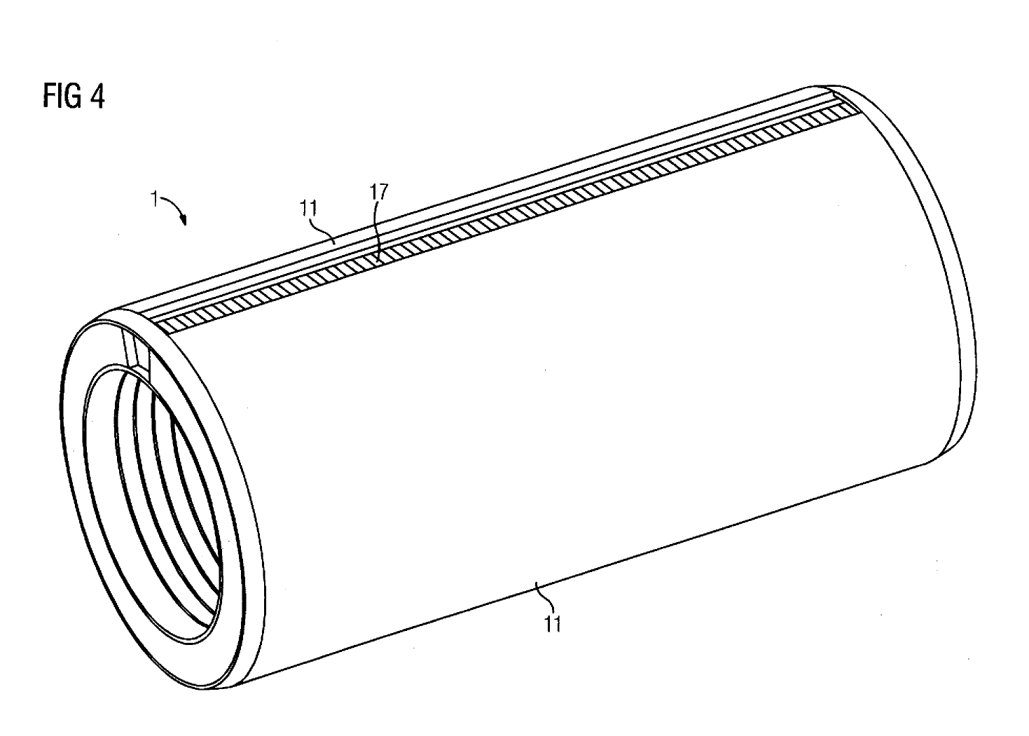

Turning now to the drawing, and in particular to FIG. 1, there is shown a cross-section through a part of a cylindrical linear motor according to the present invention, having a stator 1 which is likewise embodied in a cylinder shape and is presented in a perspective view in FIG. 4. A likewise cylindrical rotor 2 is coaxially located in the cylindrical stator 1. End shields 3, 4 are located at the front faces of the stator 1. A guide rod 5 for the rotor 2 is secured in the end shields 3, 4 in parallel with the shaft of the cylindrical linear motor. One or more further guide rods 5 of said kind are fixed in position in the end shields 3, 4 for the purpose of guiding the rotor 2. The rotor 2 is linearly mounted on the guide rod(s) 5 by guide bushings 6. Located on its outer surface in the axial direction and distributed in the circumferential direction are a plurality of permanent magnets 7.

On the outside the stator 1 is enclosed by a cooling jacket 8. Said cooling jacket 8, together with a housing 9 which in turn encloses the ribbed cooling jacket 8, forms numerous cooling ducts in which water, for example, flows for the purpose of cooling the linear motor. The end shields 3, 4 are secured, for example bolted on, to the cooling jacket 8 or the housing 9.

The stator 1 possesses numerous annular coils 10, each of which runs in the circumferential direction of the cylindrical stator 1. They are inserted into corresponding slots of the stator core 11. The slots likewise run in the circumferential direction. The stator core is conventionally formed from a ferromagnetic material and concentrates the magnetic flux of the annular coils 10.

According to the invention, the stator core 11 is laminated. It has numerous individual laminations 12 which, as shown in FIG. 2, form a comb-shaped structure. Each of the individual laminations extends in the axial direction of the cylindrical linear motor. An individual lamination possesses the axial length of the stator core, or a plurality of individual laminations are arranged one after another. In the circumferential direction of the cylindrical stator 1 the individual laminations 12 are arranged in a star shape or are aligned radially. This results in a cylinder-shaped lamination arrangement or a cylinder-shaped lamination stack.

Each individual lamination 12 possesses an axially running yoke 13 from which numerous teeth 14 protrude vertically. In the assembled state the teeth 14 point radially inward and form the walls of the slots for the annular coils 10.

By virtue of the stator core 11 being implemented as a laminated structure eddy currents can develop therein only to a very limited degree even at higher movement speeds. The electrical losses are reduced accordingly. Furthermore, the force-forming field buildup experiences a shorter delay on account of the lamination of the stator. An increase in the dynamics of the cylindrical linear motor can be achieved as a result.

In this arrangement the stator 1 has a number of 3×i annular coils, where i represents a natural number (i=1, 2, 3, . . . ). This enables the stator to be used for a three-phase winding system. The coils of the winding system are spaced apart and positioned axially by the lamination comb, i.e. the stator core with the slots. The number of teeth of the lamination comb is geared to the number of coils. An individual lamination 12 accordingly consists of at least one tooth section having the teeth 14 and a yoke section 13.

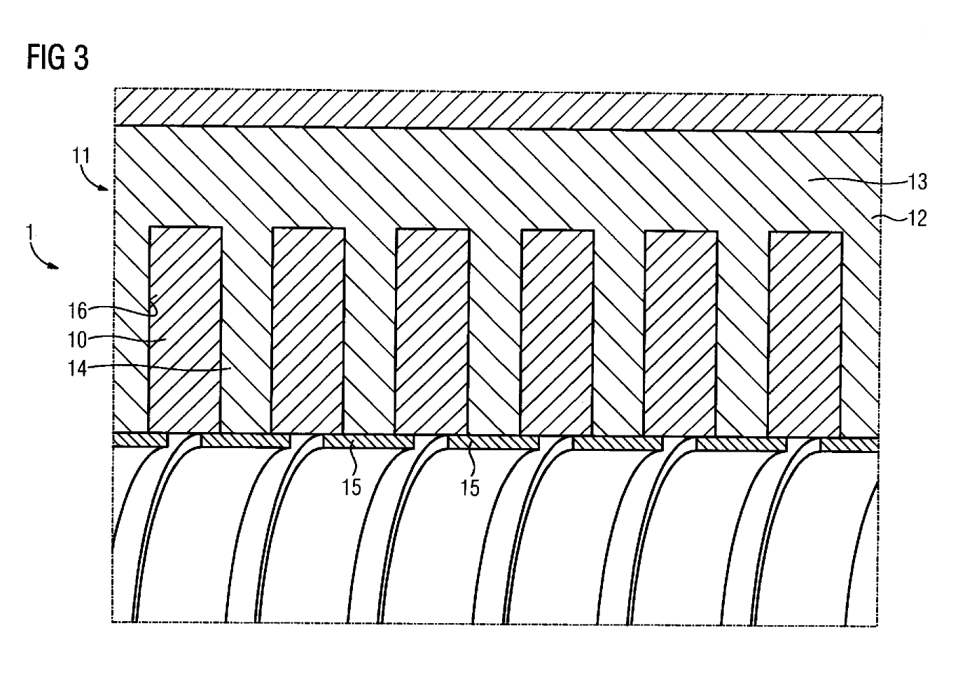

FIG. 3 presents a magnified detail of the stator 1 from FIG. 1. At the intersection this view shows an individual lamination 12 with its yoke 13 and the teeth 14. In combination with many individual laminations arranged in the circumferential direction, this produces the specifically structured stator core 11. The annular coils 10 are located between the teeth 14. Tooth tip rings 15 are located at the tooth tips, i.e. on the side of the respective tooth tips that faces toward the rotor. One tooth tip ring 15 is associated with each tooth 14. The tooth tip rings 15 therefore also run in the circumferential direction on the inside of the stator. They have several functions. On the one hand they collect the flux in the region of the tooth tips. On the other hand they fix the annular coils 10 in position in their slots 16. Toward that end they possess a somewhat greater extension in the axial direction than the teeth 14. As a result the tooth tip rings 15 partially close off the slots 16. A further important function of the tooth tip rings is that they internally support or fix in position the star-shaped arrangement of the laminations 12.

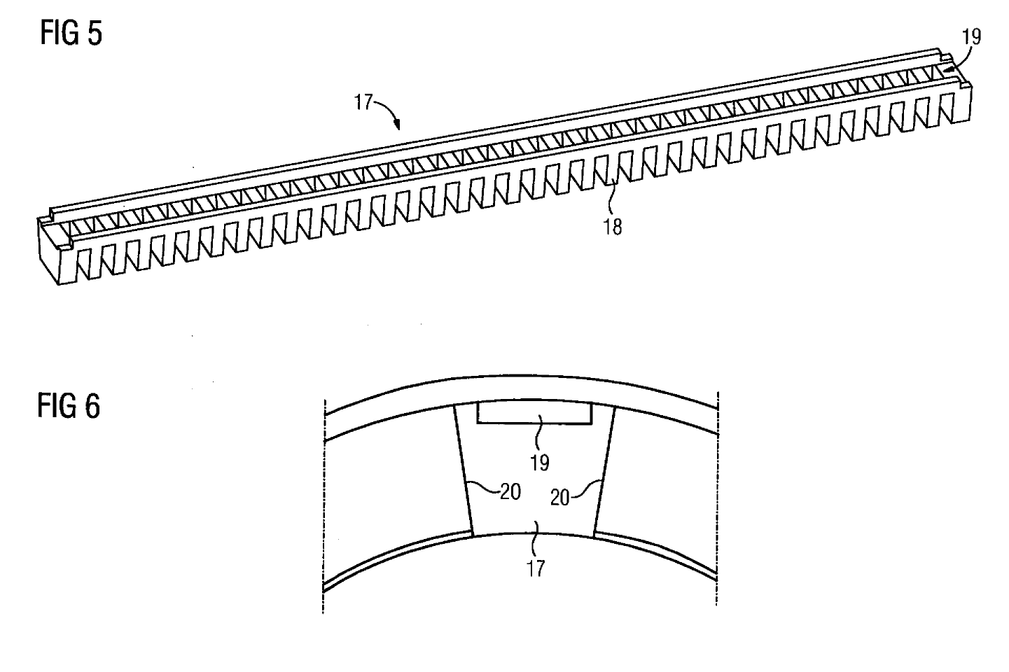

FIG. 4 shows a cylindrical stator 1 of a linear motor according to the invention. The stator core 11 is formed by the described lamination arrangement having the individual laminations arranged in a star shape. The lamination arrangement or stator core 11 is interrupted in the circumferential direction by a stator comb element 17. Said stator comb element 17 is shown individually in FIG. 5. It possesses (referred to the state inserted in the cylindrical stator core 11) a radial height corresponding to that of the stator core 11. The axial length of the stator comb element corresponds in this case to that of an individual lamination 12. However, the length of the comb element can also correspond to the length of a plurality of individual laminations, or vice versa. The structure of the stator comb element 17 on the inside (again referred to the state inserted into the cylindrical stator core 11) substantially corresponds to that of an equal-sized sector of the stator core 11 or of the lamination arrangement. This means that the stator comb element 17 possesses geometrically identically shaped teeth 18 as the lamination arrangement. Accordingly the slots of the lamination arrangement are not interrupted by the inserted stator comb element 17.

On its outside, the stator comb element 17 possesses a channel 19 which reaches under the outer protective jacket of the cylindrical stator 1. The connections between the individual coils can be established in said channel 19. In this way the annular coils can be interconnected or linked to one another in the axial direction without the necessity of increasing the radial dimension of the stator 1.

A stator comb element 17 of said type or a plurality of such stator comb elements can be arranged around the circumference of the stator 1, interrupting the stator core or the lamination arrangement either once or a number of times in the circumferential direction. The stator comb element(s) 17 can be used not just for the connecting circuit of the annular coils 10, but generally for leading out the winding terminals.

It can be seen in the front face view of FIG. 6 that a stator comb element 17 preferably possesses a structure shaped like a ring sector. The lateral surfaces 20 are radially aligned accordingly. They thus serve simultaneously as a bearing surface for the adjacent laminations.

Insulating plastic is preferably used as the material for the stator comb elements 17, although stator comb elements 17 can also be embodied as cast or sintered parts. In this event they then possess an electrical insulation layer on the surface.

The connections between the individual coils are preferably created by means of a ready-made connecting block which is positioned in the connecting circuit channel 19. The connecting circuit of the annular coils is configured such that the smallest possible latching forces are produced. The number of coils is adjusted accordingly. This results in a basic winding, and the stator possesses the length of an integral multiple of the basic winding. In the present example the basic winding is the same length as the rotor 2, and the stator 1 is twice as long as the rotor. Specifically the stator in this case possesses 36 annular coils.

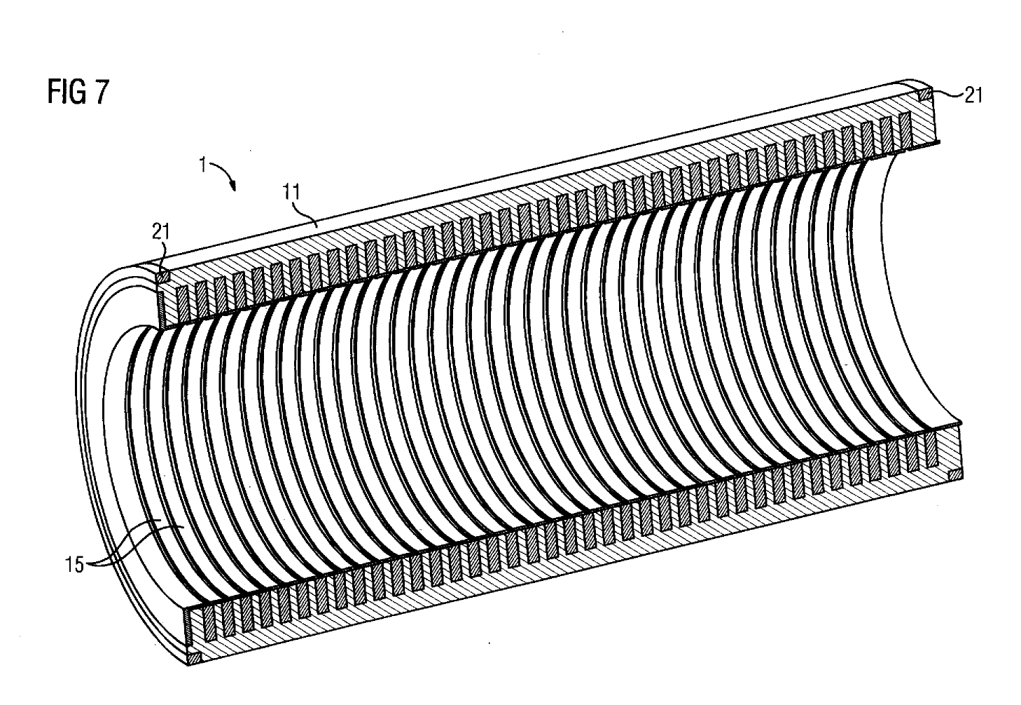

During production and in subsequent operation it is important that the individual laminations of the lamination arrangement, which are in fact arranged in a star shape, are adequately fixed in position. According to FIG. 7, the individual laminations are fixed in position radially toward the inside by means of the tooth tip rings 15. Radially toward the outside the individual laminations of the stator core are retained by means of fixing rings 21. The fixing rings 21 are located at the front face ends of the stator 1. There, they press onto respective shoulders 22 of the individual laminations 12 (see also FIG. 1). In the present example the fixing rings 21 are flush with the surface of the rest of the lamination arrangement. The fixing rings 21 therefore serve for pre-fixing the individual laminations in position both radially and axially.

As indicated in FIG. 1, a housing 9 and/or a cooling jacket 8 can serve as the external frame of the stator 1. They enclose the star-shaped lamination arrangement over its entire circumference. In order to provide a better thermal connection the stator (in particular the interspace between the individual laminations arranged in a star shape) can be sealed with resin.

The internal tooth tip rings have not only the function of a radial support, but also the function of a magnetic flux collector, as described above. This allows a higher force to be generated, thereby enabling higher dynamic characteristics to be achieved. Equally, the optional water cooling and the sealing produce a higher permissible current density and consequently also a higher force and higher dynamics.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A cylindrical linear motor, comprising:
a cylindrical rotor; and
a cylindrical stator arranged in coaxial relationship to the rotor, said stator having a plurality of annular coils which are arranged in coaxial relationship, and a ferromagnetic stator core which includes a plurality of radially aligned individual laminations.

2. The cylindrical linear motor of claim 1, wherein each of the individual laminations has a comb-like structure.

3. The cylindrical linear motor of claim 1, wherein a number of annular coils of the stator is a multiple of three.

4. The cylindrical linear motor of claim 1, wherein the stator core has teeth running in a circumferential direction, each of the teeth having a tooth tip for arrangement of a tooth tip ring.

5. The cylindrical linear motor of claim 1, wherein the individual laminations of the stator core form a lamination arrangement which has at least one interruption in a circumferential direction for insertion of a stator comb element.

6. The cylindrical linear motor of claim 5, wherein the stator comb element has an axial channel in which the annular coils are interconnectable.

7. The cylindrical linear motor of claim 5, wherein the stator comb element has an electrically insulating plastic part, an electrically insulated cast part, or an electrically insulated sintered part.

8. The cylindrical linear motor of claim 1, further comprising fixing rings placed at axial ends of the stator to secure the individual laminations of the stator core in position.

9. The cylindrical linear motor of claim 1, further comprising at least one enclosure selected from the group consisting of housing and a cooling jacket to enclose the stator core.

10. The cylindrical linear motor of claim 1, wherein the stator core is sealed by resin.
